(19) United States
(12) Patent Application Publication
(10) Pub. No.: US 2002/0133965 A1
(43) Pub. Date: Sep. 26, 2002

(54) Fish tape and measure

(76) Inventor: Donn Lanier Gilber, Roseville, CA (US)

Correspondence Address: Risto A. Rinne, Jr., 2173 East Francisco Blvd. Suite E, San Rafael, CA, 94901, US

(21) Appl. No.: 09/818,018

(22) Filed: Mar. 26, 2001

(51) Int. Cl. G01B 3/10

(52) U.S. Cl. 33/756

(57) ABSTRACT

An apparatus for measuring the length of a conduit includes a fish tape having a housing and a spool disposed in the housing and a tape with markings along its longitudinal length. The spool is adapted for grasping and pulling the tape. The tape is forced through a conduit until the end of the conduit is reached at which time the length of the conduit is determined by noting the marking that appears on the tape where the tape first enters into the conduit. A method for determining the proper length of wire that is required and of simultaneously preparing the conduit for pulling the wire includes obtaining a segment of wire of a length that exceeds that of the marking that was noted and then attaching the wire to the end of the tape that was forced through the conduit. The spool is then grasped and pulled so as to urge the tape and the wire to pass through the conduit.

### BACKGROUND OF THE INVENTION

1. Field of the Invention

The present invention, in general relates to devices used for pulling electrical wires through conduits and, more particularly, to devices that are commonly referred to as “fish tapes”.

In the electrical arts, electricians often must pull wires through pipes. To assist, a tool is used that includes a spoolable but stout material (usually metal) that is reeled off of the tool and forced in through the conduit until it exits at an opposite end.

The electrical wires are then attached to one end of spoolable material (usually by wrapping them with electrical tape) and the tool is then used to pull the spoolable material, along with the wires, through the conduit.

Once the wires are fully pulled through the conduit, the electrical tape is removed and the wires are disconnected apart from the spoolable material. The casing of the tool itself is grabbed and is used to pull, even jerk, the wires through the conduit.

After a short amount of the spooled material has been pulled it is coiled (i.e., spooled) back onto the tool. This procedure is repeated over and over until the wires have been fully pulled through the conduit and all of the spoolable material is once again coiled back into the tool itself.

Such kinds of tools are well known in the electrical wiring (commercial or residential) industry and are commonly referred to as “fish tape”. Electricians know that fish tape is used for pulling wire.

A vexing problem arises because electricians never really know how much wire is required for pulling through a conduit. Wire is expensive. When they have to buy wire for pulling (sometimes called “snaking”) through a conduit, they do not want to buy too much and have the excess go to waste. Even worse is to buy too little wire and go through all of the labor of pulling a heavy gauge wire (worse case scenario) through a long run of conduit only to run short and not have enough wire to complete the job.

The difficult labor done in vain must then be repeated as the wire is pulled out and set aside as scrap hopefully to be used again in another “job”. Then a new batch of continuous wire must be purchased, the fish tape must be run through the conduit again, the new batch of wire tied to the fish tape and pulled through. The amount paid for the original (too short) run of wire is pure waste as was the labor to pull it through the conduit only to find that it was too short, and then to pull it back out.

Sometimes, electricians will have some of the proper wire type on hand in their inventory. This may be the excess (i.e., scrap) left over from other jobs that they have completed. Usually, they tag or otherwise indicate the length of these wires when they are coiled up and stored. If not, they can always be measured.

Again, the use of scraps for pulling through conduit is a guessing game. Does the electrician think that the scrap piece is long enough? Should he gamble and go through all of the work pulling it through the conduit just to fing out?

Assume that the wire is very expensive to purchase, for example several dollars a foot and that there is a two hundred foot length of conduit to run the wire through. Assume also that the electrician has an excess (scrap) roll of wire that is 197 feet in length. He may well be tempted to “try” it and see, knowing that could possibly save thousands of dollars if it is long enough.

However, if it is too short then he risks nearly tripling the labor required, first to pull the scrap piece through the conduit only to discover that it is too short, second to remove the scrap from the conduit, and third to pull a new section of sufficiently long wire through the conduit.

When the term “wire” is used it is intended to apply to any type of wire used in the electrical wiring arts. This includes single and multiple conductor wires of any gauge and having any type of insulation that is required for the task at hand.

Electricians need to know before either purchasing wire or attempting to use scrap on hand exactly how much wire will be needed to successfully complete a particular run through a particular conduit. Electricians will normally factor in some additional length to the wire that is in excess of the length of the conduit. The additional length is for making connections at each end of the conduit.

There are no effective methods for an electrician to determine how much wire will be required. Although it is at times possible for short runs (i.e., lengths of conduit), electricians are usually unable to force a measuring tape through a conduit because measuring tapes are not sufficiently rigid enough to permit pushing them through long runs of conduit, especially conduit having multiple angled turns.

Even if they are successful in forcing the tape through the conduit, the process itself adds an extra labor cost to the wiring operation because the electrician (or assistant) must push the measuring tape through the conduit, note when it reaches the opposite end, then note the length, and then remove the measuring tape. Prior to pulling the wire, they must then insert the fish tape in the conduit.

Measuring tape is not strong enough for use as a fish tape and, therefore, it cannot be used for pulling wires through the conduit. It is impossible to “jerk” wires with a measuring tape. There is no place to grab hold of the measuring tape and if it were so used, it would break.

If the measuring tape cannot be forced through the conduit, it is possible to force (snake) the fish tape through the conduit, attach the measuring tape to the fish tape, and then pull the fish tape along with the measuring tape through the conduit until the measuring tape emerges from the conduit.

However, this is almost never done because it adds too much labor. Electricians, like so many professionals, may opt to instead go with their intuition and sometimes they painfully discover that that intuition was wrong.

Similarly, it is not feasible to use the fish tape to determine the length of the wire. This, to be tried, would require inserting the fish tape in through the conduit until it emerged from the other end and noting its length where it first entered the conduit. Then, the fish tape would have to be pulled out of the conduit and placed flat on the ground in a straight line.

One could then either measure the fish tape and go out and purchase that length of wire or place a section of scrap wire beside the fish tape to see if the scrap piece is long enough.

This will not work well for three main reasons. First, the fish tape would get dirty if it was placed on the ground and the electrician would then have great difficulty winding it back on the spool of the tool. The wire would get dirty as well and be even more difficult to pull through the conduit.

Second, the fish tape is naturally coiled and it would resist laying flat on the ground, frustrating the electrician who attempted to do so.

Third, there is seldom available a sufficient amount of space adjacent to a conduit for the electrician to lay out in a flat and straight manner both the fish tape and the scrap wire. Usually only a few feet of space are available between or inside commercial buildings, for example, and this would preclude laying a several hundred foot run of fish tape flat on the ground.

Also, this process is especially time consuming and it would add considerable labor cost.

Accordingly, there exists today a need for a fish tape and measure that can inform the electrician how much wire is needed and which does not increase the labor that is required to accomplish the task of pulling wire through a conduit.

Clearly, such an apparatus would be a useful and desirable device.

2. Description of Prior Art

Fish tapes are, in general, known. While the structural arrangements of the known types of devices may, at first appearance, have similarities with the present invention, they differ in material respects. These differences, which will be described in more detail hereinafter, are essential for the effective use of the invention and which admit of the advantages that are not available with the prior devices.

### OBJECTS AND SUMMARY OF THE INVENTION

It is an object of the present invention to provide a fish tape and measure that is economical to manufacture.

It is also an important object of the invention to provide a fish tape and measure that is easy to use.

Another object of the invention is to provide a fish tape and measure that indicates the length inside a conduit.

Still another object of the invention is to provide a fish tape and measure that can provide the length inside a conduit and which does not increase the labor required to pull a wire through a conduit.

Still yet another object of the invention is to provide a fish tape and measure that can determine the length of wire that is required inside a conduit.

Yet another important object of the invention is to provide a fish tape and measure can determine the length of wire that is required inside a section of conduit while simultaneously preparing the conduit for pulling of the wire therethrough.

Still yet another important object of the invention is to provide a fish tape and measure that is available in a plurality of lengths.

Briefly, a fish tape and measure apparatus for use in pulling wires and measuring conduits that is constructed in accordance with the principles of the present invention includes a predetermined length of fish tape and a housing that includes a center disposed spool that is adapted for both coiling and pulling of the fish tape. A plurality of markings on the fish tape indicate the longitudinal length thereof.

### BRIEF DESCRIPTION OF THE DRAWINGS

FIG. 1 is a view in perspective of a fish tape and measure.

FIG. 1a is a segment of the tape portion of the fish tape of FIG. 1.

### DETAILED DESCRIPTION OF THE INVENTION

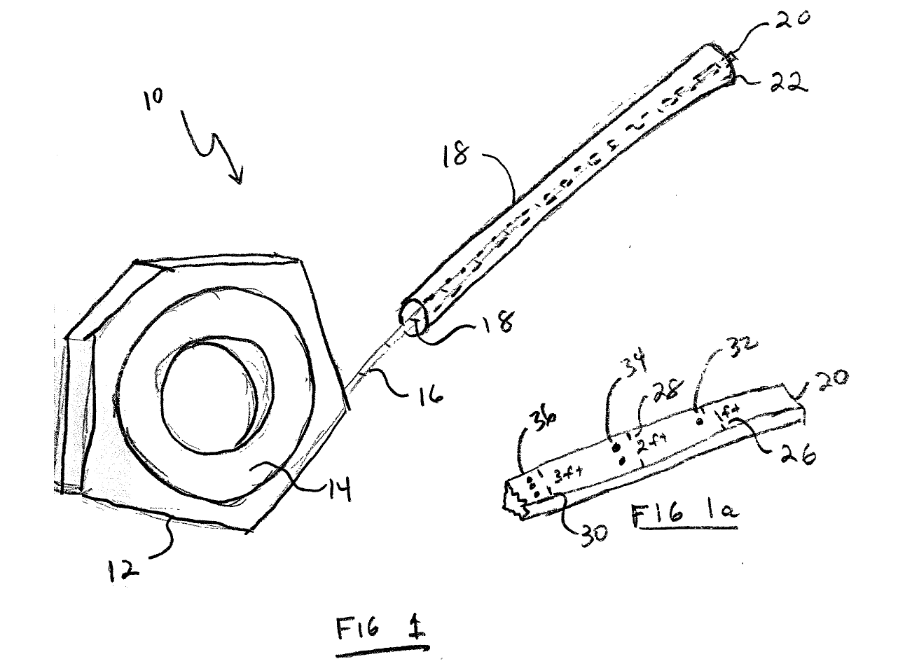

Referring to both drawings and in particular to FIG. 1 is shown, a fish tape and measure, identified in general by the reference numeral 10.

The fish tape and measure 10 includes a housing 12 that has a spool 14 inside that is used to wind up (i.e., to spool) a length of tape 16.

In use, the housing 16 and spool 14 are grasped and pulled to pull the tape 16 through a conduit 18.

As shown, the tape 16 has been pushed into the conduit 18 until an end 20 of the tape 16 reaches a far end 22 of the conduit 18.

Different manufactures currently offer various similar types of products known as fish tapes but they do not include certain of the elements of the instant invention as are described in greater detail hereinafter. GARDNER BENDER is the tradename for one manufacturer of common types of fish tapes and another is GREELEE.

Common lengths of the commercially available fish tapes include 50 feet, 100 feet, 200 feet, 250 feet, and 500 feet.

The tape 16 of the fish tape and measure 10 is also of any preferred length as is desired. The tape 16 is made of any preferred material but it is generally similar to that as used in the above commercially available devices which typically are made of tempered metals or nylon and have a width of approximately one-eight of an inch and a thickness of approximately 0.060 inches.

A user (not shown) can read the length of the conduit 18 by looking at a length marking 24 that corresponds to where the tape 16 first enters the conduit 18.

A plurality of markings 26-30 (see FIG. 1a) indicate the length (i.e., the amount) of the tape 16 that is in the conduit 18. The plurality of markings 26-30 are preferably in feet, but they could be in inches or yards, or metric, as desired. The entire length of the tape 16 includes additional markings (not shown) that progressively increase in magnitude.

The plurality of markings 26-30 and the length marking 24 may be inscribed, painted, etched, or otherwise attached to the tape 16, as desired.

An alternate first marking 32 includes a single raised protrusion which provides an encoded indication of the length of the tape 16 to this point. An alternate second marking 34 includes a pair of raised protrusions which provide an encoded indication of the length of the tape 16 to this area. An alternate third marking 36 includes three raised protrusions. This may be continued as desired or other encodation schemes may be employed.

The alternate first, second, and third markings 32, 34, 36 provide a way in which the length can be determined by tactile means, that is, feel without having to look at the tape 16. This is useful if it is dark or if direct viewing of the tape 16 is difficult to accomplish.

The invention has been shown, described, and illustrated in substantial detail with reference to the presently preferred embodiment. It will be understood by those skilled in this art that other and further changes and modifications may be made without departing from the spirit and scope of the invention which is defined by the claims appended hereto.

What is claimed is:

1. A fish tape and measure, comprising:
(a) means for providing a housing;
(b) means for providing a tape, said tape disposed in a spool, said spool disposed in said housing and wherein said spool is adapted for pulling, and wherein said tape is adapted to be pulled a predetermined distance out of said housing; and
(c) means for indicating the longitudinal length of said tape.

2. The fish tape and measure of claim 1 wherein said tape formed out of a flexible material having a rectangular cross sectional profile and having a width of approximately 0.125 inches and a thickness of approximately 0.060 inches.

3. The fish tape and measure of claim 1 wherein said means for indicating the longitudinal length includes a plurality of demarcations disposed on said tape.

4. The fish tape and measure of claim 3 wherein said demarcations include a unit of measure.

5. The fish tape and measure of claim 4 wherein said unit of measure includes feet.

6. The fish tape and measure of claim 1 wherein said means for indicating the longitudinal length includes visible means.

7. The fish tape and measure of claim 1 wherein said means for indicating the longitudinal length includes tactile means.

8. The fish tape and measure of claim 1 wherein said means for indicating the longitudinal length includes encoded means.

9. A method of determining the length of a conduit, comprising the steps of:
(a) inserting a first end of a fish tape into a first end of a conduit, said fish tape including markings along its longitudinal length that correspond to its length;
(b) pushing the fish tape into the conduit until the first end of the fish tape reaches a second end of the conduit; and
(c) reading the marking that is disposed proximate the first end of the conduit.

10. A method of determining the length of a conduit and of pulling a wire therethrough, comprising the steps of:
(a) inserting a first end of a fish tape into a first end of a conduit, said fish tape including markings along its longitudinal length that correspond to its length;
(b) pushing the fish tape into the conduit until the first end of the fish tape reaches a second end of the conduit;
(c) reading the marking that is disposed proximate the first end of the conduit;
(d) attaching a first end of said wire to the first end of the fish tape; and
(e) pulling the fish tape out of the conduit.
